(19) United States
(12) Patent Application Publication
(10) Pub. No.: US 2019/0047071 A1
(43) Pub. Date: Feb. 14, 2019

(54) METHOD FOR MANUFACTURING COMPONENT

(71) Applicants: FUTABA INDUSTRIAL CO., LTD., Okazaki-shi (JP); TOYOTA JIDOSHA KABUSHIKI KAISHA, Toyota-shi (JP)

(72) Inventors: Kengo Umekawa, Okazaki-shi (JP); Yuji Nakazono, Toyota-shi (JP); Shinichiro Hattori, Toyota-shi (JP); Nobuya Sakimoto, Nagoya-shi (JP)

(21) Appl. No.: 16/101,305

(22) Filed: Aug. 10, 2018

(30) Foreign Application Priority Data
Aug. 14, 2017 (JP) 2017-156590

(51) Int. Cl. B23K 9/235; B23K 9/16; B23K 9/23

(52) U.S. Cl. CPC B23K 9/235; B23K 9/23; B23K 9/16

(57) ABSTRACT

Outer surfaces of aluminum members are provided with a welding line extending from a first end to a second end, and a preliminary line extending from a third end to a fourth end. The fourth end of the preliminary line is connected to the first end of the welding line. Arc welding along the preliminary line and the arc welding along the welding line are consecutively performed. An angle formed by a straight line extending from the fourth end toward the third end in a preliminary line direction, and a straight line extending from the first end toward the second end in a welding line direction is an obtuse angle.

### CROSS-REFERENCE TO RELATED APPLICATIONS

The present application claims the benefit of Japanese Patent Application No. 2017-156590 filed on Aug. 14, 2017 with the Japan Patent Office, the entire disclosure of which is incorporated herein by reference.

### BACKGROUND

The present disclosure relates to a method involving arc welding for manufacturing a component.

An aluminum component has, on its outer surface, an oxide film with a high melting point. Before welding aluminum members of an aluminum component, preheat needs to be applied to these aluminum members so that their oxide films melt more easily.

For example, Japanese Unexamined Patent Application Publication No. 2005-40812 discloses a method that improves the quality of welding aluminum members. Specifically, JP2005-40812 discloses that, when welding of the aluminum members by metal inert gas (MIG) welding is started, the output voltage and the arc length are controlled depending on the state of the oxide films.

### SUMMARY

However, the aforementioned method makes the process of welding aluminum members complicated.

It is preferable that one aspect of the present disclosure provides a simple method for arc welding of aluminum or aluminum alloys.

In a manufacturing method according to one aspect of the present disclosure, a component obtained by joining aluminum members made of metal including aluminum is manufactured by arc welding in which an arc is discharged from a welding wire extending from a leading end portion of a welding torch. The welding torch is configured to emit a shielding gas toward an arc welding portion where the arc welding is to be performed. Outer surfaces of the aluminum members are provided with a welding line extending from a first end to a second end, and a preliminary line extending from a third end to a fourth end. The fourth end of the preliminary line is connected to the first end of the welding line.

While the welding wire is maintained so as to extend perpendicularly to the arc welding portion on the outer surfaces, or maintained so as to extend in an advancing angle direction, the arc welding along the preliminary line from the third end to the fourth end, and the arc welding along the welding line from the first end to the second end are consecutively performed. The advancing angle direction is a direction in which the welding wire extends such that a tip of the welding wire is positioned toward the second end relative to a root of the welding wire when the arc welding is performed along the welding line.

A direction in which the preliminary line extends at the fourth end is a preliminary line direction. A direction in which the welding line extends at the first end is a welding line direction. The preliminary line is adjusted such that a smaller angle out of angles formed by a straight line extending from the fourth end toward the third end in the preliminary line direction, and a straight line extending from the first end toward the second end in the welding line direction becomes an obtuse angle.

According to this method, prior to the arc welding along the welding line, the arc welding along the preliminary line is performed. In this way, the aluminum members are preheated. Thus, welding along the welding line can be performed in a preferable manner.

The welding wire is maintained to extend in a direction perpendicular to the arc welding portion or to extend in the advancing angle direction. Accordingly, the shielding gas is emitted toward the welding advancing direction when arc welding is performed along the welding line. As a result, some part of the aluminum members on the welding line can be effectively covered by the shielding gas before arc welding is started. This can inhibit an entry of atmosphere into the arc welding portion which causes a temperature increase in the arc welding portion, and consequently inhibit a formation of blowholes in the arc welding portion.

The angle between the preliminary line and the welding line is an obtuse angle. A large change in the welding advancing direction can be inhibited when arc welding along the preliminary line is completed and arc welding along the welding line is started. When arc welding along the welding line is started, some part of the aluminum members on the welding line can be effectively covered by the shielding gas prior to arc welding. This can inhibit an entry of atmosphere into the arc welding portion which causes a temperature increase in the arc welding portion, and consequently inhibit a formation of blowholes in the arc welding portion. Moreover, since the angle that is formed when the welding advancing direction is changed at the start of arc welding along the welding line is an obtuse angle, the advancing speed of welding can be inhibited from being reduced. In other words, the welding advancing direction can be more quickly changed to start arc welding along the welding line. Accordingly, excessive heating can be inhibited in the vicinity of the intersection of the welding line and the preliminary line, and arc welding can be performed with consistent quality.

Accordingly, arc welding of aluminum or aluminum alloys can be preferably performed by a simple method.

The component obtained by joining the aluminum members may be a component to be installed in a vehicle.

According to the aforementioned method, when a component to be installed in a vehicle is manufactured, arc welding of aluminum or aluminum alloys can be performed in a simple and a preferable manner.

The arc welding may be one of metal inert gas (MIG) welding, metal active gas (MAG) welding, tungsten inert gas (TIG) welding, and plasma welding.

According to the aforementioned method, MIG welding, MAG welding, TIG welding, or plasma welding of aluminum or aluminum alloys can be performed in a simple and a preferable manner.

The welding wire may extend linearly. This allows arc welding to be performed in a more preferable manner.

The welding wire may be inclined relative to a vertical direction, and an angle of the welding wire relative to the vertical direction may be larger than 0° and smaller than 20°.

According to the aforementioned method, when arc welding is performed along the welding line, the welding wire can be preferably maintained to extend in the advancing angle direction.

The shielding gas may be emitted from the leading end portion along the welding wire.

According to the aforementioned method, the shielding gas can be preferably emitted toward the arc welding portion where arc welding is to be performed. Moreover, the shielding gas can be preferably emitted toward the welding advancing direction when arc welding is performed along the welding line.

The welding line may be a straight line, or may alternatively be a curved line.

The preliminary line may be a straight line, or may alternatively be a curved line.

The same effects can be also achieved by these alternatives.

### BRIEF DESCRIPTION OF THE DRAWINGS

An example embodiment of the present disclosure will be described hereinafter by way of example with reference to the accompanying drawings, in which:

FIG. 1A is an explanatory view showing a welding torch;

FIG. 1B is a perspective view showing one example of a preliminary line and a welding line;

FIG. 2A is a top view showing the example of the preliminary line and the welding line; and

FIG. 2B is a top view showing another example of the preliminary line and the welding line.

### DETAILED DESCRIPTION OF THE PREFERRED EMBODIMENTS

The embodiment of the present disclosure is not limited to the following embodiments, and can be variously modified within the technical scope of the present disclosure.

### Description of Manufacturing Method

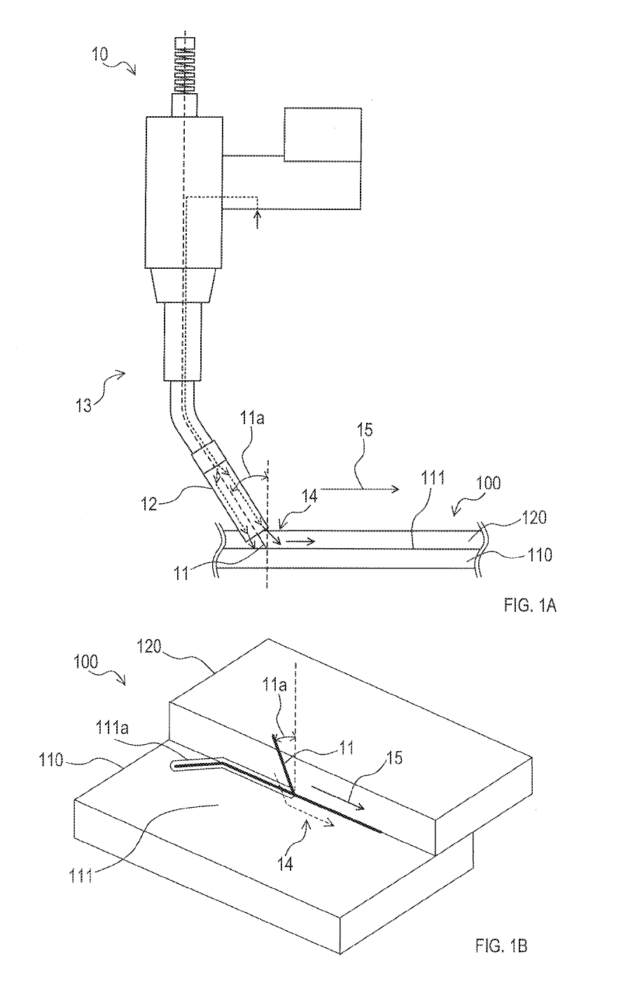

As shown in FIG. 1A, a joined component 100 is manufactured by arc welding according to the manufacturing method of the present embodiment. The joined component 100 may be a component used, for example, for a vehicle such as an automobile. Arc welding is a welding method that uses heat of an arc discharge generated by electric current. In the present embodiment, metal inert gas (MIG) welding is used as one example. Alternatively, other types of arc welding that utilizes a shielding gas may be used, such as metal active gas (MAG) welding, tungsten inert gas (TIG) welding, and plasma welding.

In the arc welding according to the present embodiment, a welding torch 10 shown in FIG. 1A is used. The welding torch 10 comprises a body 13, a leading end portion 12, and a welding wire 11.

The body 13 has an elongated shape, and is bent such that the leading end of the body 13 is inclined relative to the vertical direction.

The leading end portion 12 is an elongated portion projecting from the tip of the body 13. The leading end portion 12 extends in a direction inclined relative to the vertical direction. Moreover, the leading end portion 12 is configured to emit a shielding gas 14 from its tip, when arc welding is performed. Once emitted, the shielding gas 14 flows toward an arc welding portion of a base material. The shielding gas 14 may be emitted from the tip of the leading end portion 12 along a direction in which the welding wire 11 extends.

The welding wire 11 is used as an electrode where an arc discharge takes place when arc welding is performed. The welding wire 11 is disposed so as to penetrate the welding torch 10 along the body 13 and the leading end portion 12. Moreover, the welding wire 11 extends, for example, linearly from the tip of the leading end portion 12 in the extending direction of the leading end portion 12. More specifically, as shown in FIGS. 1A and 1B, the welding wire 11, extending from the tip of the leading end portion 12, is inclined such that an angle 11a relative to the vertical direction becomes X°. The X° may be an angle that is, for example, larger than 0° and smaller than 90°. The X° may be, for another example, larger than 0° and smaller than 20°. The X° may be, for another example, 10° or approximately 10°. The portion of the welding wire 11 extending from the tip of the leading end portion 12 may be, for example, bent or curved.

In the manufacturing process of the joined component 100, aluminum members 110, 120 made of metal including aluminum are joined by arc welding. The joined component 100 is obtained by joining the aluminum members 110, 120. Each of the aluminum members 110, 120 may be, for example, a member made of aluminum, or may be made of an alloy including aluminum.

More specifically, arc welding is performed along a welding line provided on the outer surfaces of the aluminum members 110, 120. The welding line is provided, for example, to some part on the outer surfaces where the aluminum members 110, 120 are in contact with each other, and extends from a first end to a second end. A preliminary line is also provided on the outer surfaces. The preliminary line extends from a third end to a fourth end, and the fourth end is connected to the first end of the welding line.

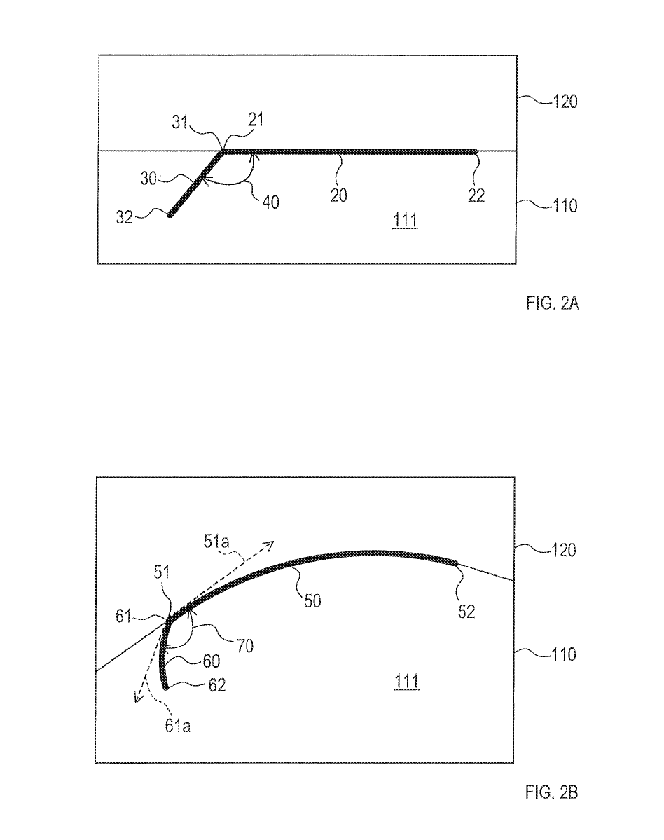

As shown in FIGS. 1A, 1B, in the present embodiment, the aluminum members 110, 120 include, for example, the aluminum member 120 in the upper side and the aluminum member 110 in the lower side that are stacked plate-shaped members. As shown in FIGS. 1B, 2A, a straight welding line 20, for example, may be provided on a welding surface 111 that is the outer surface of the lower aluminum member 110. The welding line 20 may be provided, for example, in a portion of the welding surface 111 in contact with the rim of the upper aluminum member 120. As shown in FIG. 2B, the rim of the upper aluminum member 120 may be curved. In this case, a curved welding line 50, for example, may be provided in the portion of the welding surface 111 in contact with the rim of the upper aluminum member 120. Alternatively, the straight welding line 20 or the curved welding line 50 may be provided, for example, in the vicinity of the portion of the welding surface 111 in contact with the rim of the upper aluminum member 120.

As shown in FIGS. 1B, 2A, a straight preliminary line 30, for example, connected to the straight welding line 20 may be provided on the welding surface 111. Alternatively, as shown in FIG. 2B, a curved preliminary line 60, for example, connected to the curved welding line 50 may be provided on the welding surface 111. It goes without saying that a curved preliminary line connected to the straight welding line 20, or a straight preliminary line connected to the curved welding line 50 may be provided.

The preliminary line may be provided so as to extend across the outer surfaces of the aluminum members. The welding surface 111 may be, for example, a flat, a curved, or an uneven surface.

The direction in which the preliminary line extends at the fourth end is defined as a preliminary line direction. As shown in FIG. 2A, in the case where the preliminary line 30 is straight, the direction in which the preliminary line 30 extends is the preliminary line direction. As shown in FIG. 2B, in the case where the preliminary line 60 is curved, the direction in which a tangent 61a of the preliminary line 60 extends at the fourth end 61 is the preliminary line direction.

The direction of the welding line extending at the first end is defined as the welding line direction. As shown in FIG. 2A, in the case where the welding line 20 is straight, the direction in which the welding line 20 extends is the welding line direction. As shown in FIG. 2B, in the case where the welding line 50 is curved, the direction in which a tangent 51a of the welding line 50 extends at the first end 51 is the welding line direction.

The preliminary line is adjusted such that the approach angle relative to the welding line becomes an obtuse angle. The obtuse angle means an angle lager than 90° and smaller than 180°. The approach angle means the smaller angle out of the angles formed by a first straight line and a second straight line. The first straight line extends from the fourth end of preliminary line toward the third end in the preliminary line direction. The second straight line extends from the first end of the welding line toward the second end in the welding line direction.

Specifically, as shown in FIG. 2A, in the case where the welding line 20 and the preliminary line 30 are both straight lines, the smaller angle out of the angles formed by the welding line 20 and the preliminary line 30 at the first end 21 (in other words, the fourth end 31) is an approach angle 40. As shown in FIG. 2B, in the case where the welding line 50 and the preliminary line 60 are both curved lines, the smaller angle out of the angles formed by the tangent 51a of the welding line 50 at the first end 51 and the tangent 61a of the preliminary line 60 at the fourth end 61 is an approach angle 70. The tangent 51a of the welding line 50 extends from the first end 51 toward the second end 52. The tangent 61a of the preliminary line 60 extends from the fourth end 61 toward the third end 62.

To join the aluminum members 110, 120, arc welding from the third end 32 (62 in FIG. 2B) toward the fourth end 31 (61) along the preliminary line 30 (60), and arc welding from the first end 21 (51) toward the second end 22 (52) along the welding line 20 (50) are consecutively performed. More specifically, arc welding from the third end 32 (62) toward the fourth end 31 (61) along the preliminary line 30 (60) is first performed. When the arc welding along the preliminary line 30 (60) reaches the fourth end 31 (61), the advancing direction of the welding is instantly changed, and the arc welding from the first end 21 (51) toward the second end 22 (52) along the welding line 20 (50) is performed.

When arc welding is performed along the preliminary line and the welding line, at least the direction of the leading end portion 12 of the welding torch 10 is adjusted such that the welding wire 11 extending from the leading end portion 12 is maintained to extend in an advancing angle direction or in a perpendicular direction. FIG. 1B shows a bead 111a formed by arc welding along the preliminary line 30 and the welding line 20. When arc welding is performed along the welding line, the direction of the leading end portion 12 and so on may be adjusted such that the shielding gas is consistently emitted from the leading end portion 12 in the advancing angle direction.

The advancing angle direction is a direction in which the welding wire 11 extends, when arc welding is performed along the welding line, such that the tip of the welding wire 11 is positioned toward the second end relative to the root thereof. In other words, the advancing angle direction is a direction in which the welding wire 11 extends, as shown in FIGS. 1A, 1B, such that the tip of the welding wire 11 is positioned toward a welding advancing direction 15 relative to the root thereof. The perpendicular direction is a direction perpendicular to some part of the outer surfaces of the aluminum members 110, 120 where arc welding is to be performed.

In the present embodiment, the welding wire 11 extending from the leading end portion 12 is inclined at X°, which is described above, relative to the vertical direction. Thus, in the case, for example, where the welding surface is flat and placed horizontally when arc welding is performed, the welding wire 11 is inclined at X° relative to the normal line of the welding surface. When arc welding is performed along the welding line, in order to maintain a state wherein the welding wire 11 extends in the advancing angle direction or in the perpendicular direction, an adjustment is made in, for example, the advancing direction of the welding, or the direction of the aluminum members 110, 120. In the case, for example, where the flat welding surface is not horizontally placed, or the welding surface is curved, a similar adjustment is made so as to maintain the aforementioned state, when arc welding is performed along the welding line.

### Effects

(1) According to the aforementioned embodiment, prior to arc welding along the welding line, arc welding along the preliminary line is performed. In this way, the aluminum members 110, 120 are preheated. Thus, welding along the welding line can be performed in a preferable manner.

The welding wire 11 is maintained to extend in the advancing angle direction or in the perpendicular direction. Accordingly, the shielding gas is emitted toward the welding advancing direction 15 when arc welding is performed along the welding line. As a result, some part of the aluminum members 110, 120 on the welding line can be effectively covered by the shielding gas before arc welding is performed. This can inhibit an entry of atmosphere into the arc welding portion which causes a temperature increase in the arc welding portion, and consequently inhibit a formation of blowholes in the arc welding portion.

However, in the case where the approach angle between the preliminary line and the welding line is an acute angle, the advancing direction of the welding is largely changed when arc welding along the preliminary line is completed and arc welding along the welding line is started. The shielding gas cannot be sufficiently emitted toward the welding advancing direction 15 when arc welding along the welding line is started. This hinders an effective covering of the portions of the aluminum members 110, 120 on the welding line by the shielding gas. As a result, atmosphere enters the arc welding portion which cases an increase in the temperature of the arc welding portion, and blowholes are likely to be formed. Moreover, the acute approach angle hinders a quick change in the welding advancing direction, which in turn causes excessive heating in the vicinity of the intersection of the welding line and the preliminary line.

Contrarily, in the aforementioned embodiment, the approach angle between the preliminary line and the welding line is an obtuse angle. A large change in the welding advancing direction can be inhibited when arc welding along the preliminary line is completed and arc welding along the welding line is started. When arc welding along the welding line is started, some part of the aluminum members 110, 120 on the welding line can be effectively covered by the shielding gas prior to arc welding. This can inhibit an entry of atmosphere into the arc welding portion which causes a temperature increase in the arc welding portion, and consequently inhibit a formation of blowholes in the arc welding portion. Moreover, since the angle that is formed when the advancing direction of the welding is changed at the start of arc welding along the welding line is an obtuse angle, the advancing speed of welding can be inhibited from being reduced. In other words, the welding advancing direction can be quickly changed to start arc welding along the welding line. Accordingly, excessive heating can be inhibited in the vicinity of the intersection of the welding line and the preliminary line, and arc welding can be performed with consistent quality.

Accordingly, the aluminum members 110, 120 can be preferably arc-welded by a simple arc welding method without, for example, checking the state of the oxide films of the aluminum members 110, 120, or adjusting the output voltage or the arc length.

(2) In the case where the angle 11a of the welding wire 11 relative to the vertical direction is larger than 0° and smaller than 20°, the welding wire 11 can be preferably maintained to extend in the advancing angle direction when arc welding is performed along the welding line.

(3) The shielding gas is emitted from the leading end portion 12 of the welding torch 10 along the welding wire 11. Accordingly, the shielding gas can be preferably emitted toward the portion where arc welding is to be performed. In addition, the shielding gas can be preferably emitted toward the welding advancing direction 15 when arc welding is performed along the welding line.

### Other Embodiments

(1) The aforementioned embodiment has described cases where the welding line and the preliminary line are both straight lines and are both curved lines. Alternatively, one of the welding line and the preliminary line may be a straight line and the other may be a curved line.

(2) It may be possible to divide a function of one element in the above-described embodiment to a plurality of elements, or to integrate functions of a plurality of elements into one element. Also, the configurations in the above-described embodiments may be partly omitted only if the problems to be solved. Any form that falls within the scope of the technical idea defined by the language of the appended claims may be an embodiment of the present disclosure.

(3) The method for manufacturing the joined component 100 in the above-described embodiment may also be implemented as follows. According to the manufacturing method, the joined component 100 is manufactured that is obtained by joining aluminum members 110, 120 made of metal including aluminum by the arc welding in which an arc is discharged from the welding wire 11 extending from the leading end portion 12 of the welding torch 10 configured to emit the shielding gas toward the arc welding portion where the arc welding is to be performed.

In a first step, the outer surfaces of the aluminum members 110, 120 are provided with the welding line 20 (50) extending from the first end 21 (51) to the second end 22 (52), and the preliminary line 30 (60) extending from the third end 32 (62) to the fourth end 31 (61). The fourth end 31 (61) of the preliminary line is connected to the first end 21 (51) of the welding line.

Similarly to the above-described embodiment, the preliminary line 30 (60) is adjusted such that the smaller angle 40 (70) out of the angles formed by the straight line, extending from the fourth end 31 (61) toward the third end 32 (62) in the preliminary line direction, and the straight line, extending from the first end 21 (51) toward the second end 22 (52) in the welding line direction, becomes an obtuse angle.

In a second step, the direction of the welding wire 11 is adjusted such that the welding wire 11 extends perpendicularly to the arc welding portion on the outer surfaces, or extends in the aforementioned advancing angle direction.

The order to perform the first step and the second step is suitably determined. In the case where the direction of the welding wire 11 has been already adjusted, the second step may be omitted.

In the third step, while the direction of the welding wire 11 adjusted in the second step is maintained, the arc welding along the preliminary line 30 (60) from the third end 32 (62) to the fourth end 31 (61), and the arc welding along the welding line 20 (50) from the first end 21 (51) to the second end 22 (52) are consecutively performed.

What is claimed is:

1. A method for manufacturing a component obtained by joining aluminum members made of metal including aluminum by arc welding in which an arc is discharged from a welding wire extending from a leading end portion of a welding torch,
wherein the welding torch is configured to emit a shielding gas toward an arc welding portion where the arc welding is to be performed,
wherein outer surfaces of the aluminum members are provided with a welding line extending from a first end to a second end, and a preliminary line extending from a third end to a fourth end, the fourth end of the preliminary line being connected to the first end of the welding line,
wherein, while the welding wire is maintained so as to extend perpendicularly to the arc welding portion on the outer surfaces, or maintained so as to extend in an advancing angle direction, the arc welding along the preliminary line from the third end to the fourth end, and the arc welding along the welding line from the first end to the second end are consecutively performed,
wherein the advancing angle direction is a direction in which the welding wire extends such that a tip of the welding wire is positioned toward the second end relative to a root of the welding wire when the arc welding is performed along the welding line,
wherein a direction in which the preliminary line extends at the fourth end is a preliminary line direction,
wherein a direction in which the welding line extends at the first end is a welding line direction, and
wherein the preliminary line is adjusted such that a smaller angle out of angles formed by a straight line, extending from the fourth end toward the third end in the preliminary line direction, and a straight line, extending from the first end toward the second end in the welding line direction, becomes an obtuse angle.

2. The method for manufacturing the component according to claim 1,
wherein the component obtained by joining the aluminum members is a component to be installed in a vehicle.

3. The method for manufacturing the component according to claim 1,
wherein the arc welding is one of metal inert gas (MIG) welding, metal active gas (MAG) welding, tungsten inert gas (TIG) welding, and plasma welding.

4. The method for manufacturing the component according to claim 1,
wherein the welding wire extends linearly.

5. The method for manufacturing the component according to claim 4,
wherein the welding wire is inclined relative to a vertical direction, and
wherein an angle of the welding wire relative to the vertical direction is larger than 0° and smaller than 20°.

6. The method for manufacturing the component according to claim 1,
wherein the shielding gas is emitted from the leading end portion along the welding wire.

7. The method for manufacturing the component according to claim 1,
wherein the welding line is a straight line.

8. The method for manufacturing the component according to claim 1,
wherein the welding line is a curved line.

9. The method for manufacturing the component according to claim 1,
wherein the preliminary line is a straight line.

10. The method for manufacturing the component according to claim 1,
wherein the preliminary line is a curved line.
